(19) United States
(12) Patent Application Publication
(10) Pub. No.: US 2009/0166274 A1
(43) Pub. Date: Jul. 2, 2009

(54) Engine valve with a combined engine oil filter and valve actuator solenoid

(75) Inventors: Kelly M. Newby, Gross Pointe Farms, MI (US); Robert D. Keller, Davisburg, MI (US)

Correspondence Address: Donald J. Harrington;Brooks Kushman P.C., 1000 Town Center, 22nd Floor, Southfield, MI, 48075-1238, US

(73) Assignee: Eaton Corporation, Cleveland, OH (US)

(21) Appl. No.: 11/805,669

(22) Filed: May 24, 2007

(51) Int. Cl. B01D 29/60

(52) U.S. Cl. 210/137

(57) ABSTRACT

The disclosed fluid filter screen assembly includes a filter body with an embedded filter screen, the filter screen being disposed in a fluid flow path between flow inlet and flow outlet openings in the filter body. A magnet effectively in contact with the filter screen increases the capacity of the filter assembly to separate particles from the fluid flow path.

### BACKGROUND OF THE INVENTION

1. Field of the Invention

The invention relates to a screen filter assembly for use with an engine oil flow control valve.

2. Background Art

An internal combustion engine design commonly used in contemporary vehicles includes an engine lubricating oil flow circuit with an engine lubrication oil pump. Engine lubrication oil cools engine components and provides a lubrication oil film at the cylinder walls. Engine oil may be used also as a fluid medium for engine hydraulic valve lifters. A solenoid operated engine oil control valve can be used to activate and deactivate the engine valve lifters as well as switch latching mechanisms in valve lifters, roller rocker arms and lash adjusters.

A presence of particles with magnetic properties, such as certain ferrous particles, as well as other non-ferrous particles, in the engine lubrication oil supply will interfere with the function of the valve lifters and will adversely affect the performance of other lubricated moving components of the engine. It is a known design practice, therefore, to provide a screen filter as part of an engine oil control valve to prevent migration of such particles in the engine lubrication oil passages.

One example of an engine oil control valve with an engine oil filter in a hydraulic valve lifter system is disclosed in U.S. Pat. No. 6,581,634. The engine oil control valve disclosed in the '634 patent includes a permanent magnet situated at the flow inlet side of a solenoid actuated control valve to capture ferrous particles in the engine oil flow stream before they enter the engine oil flow circuit leading to movable engine components, including pressure operated valve lifters.

Another example of a solenoid operated engine oil flow valve is disclosed in U.S. Pat. No. 6,209,563, which includes a filter screen on the upstream side of the valve. That valve assembly, however, does not include a magnet in the engine oil flow stream as in the case of the design shown in the '634 patent.

### SUMMARY OF THE INVENTION

The present invention comprises a solenoid operated engine oil flow control valve in which a filter screen, a magnet and a solenoid operated valve can be combined into a single assembly. This involves combining three components into a single part during manufacture. It will permit the single part to be customized for a special customer requirement. It is an objective of the invention, furthermore, to provide an engine oil flow control valve and filter that can be manufactured at reduced costs and with reduced manufacturing time.

According to a further feature of the invention, the magnet is molded into a separate filter body, which can be pressed into a valve body or otherwise secured in the valve body during manufacture. The magnet has a magnetic field in proximity to the filter screen itself, thereby magnetizing the filter screen and enhancing the ability of the assembly to capture particles in the engine oil flow circuit before they can be distributed to moving parts of the engine.

During manufacture of an engine, numerous machining operations are required. Machining debris, such as small chips and microscopic particles, may be retained in an engine block and cylinder head prior to assembly of the engine in an automotive vehicle powertrain. The filter screen assembly of the invention will effectively capture such debris during repetitive circulation of the engine lubrication oil through the engine from an engine oil pump.

According to another feature of the invention, the filter screen may be in contact with the magnet or in close proximity to the magnet so that the entire screen is magnetized, thereby increasing the ability of the screen filter assembly to capture particles with magnetic properties, such as ferrous particles.

According to another feature of the invention, the filter screen is provided with a significantly increased flow area in comparison to prior art filter designs, thereby further enhancing the ability of the assembly to capture ferrous particles and other non-ferrous particles.

According to a further feature of the invention, the filter screen is used to provide a screening function at the flow outlet side of main engine oil flow ports in the filter assembly, whereby the filter assembly has a second opportunity to capture particles that may not have been captured at the main oil flow ports.

### BRIEF DESCRIPTION OF THE DRAWINGS

FIG. 1a is a partial sectional isometric view of a filter assembly for an engine oil flow circuit that includes the invention;

FIG. 1b is a partial cross-sectional view of the filter assembly and engine oil flow control valve illustrated partially in FIG. 1a;

FIG. 2 is a cross-sectional isometric view of the filter assembly used in the construction of FIGS. 1a and 1b;

FIG. 3 is a isometric overall view of the filter assembly of FIG. 2;

FIG. 4 is an end view of the filter assembly seen in FIG. 3;

FIG. 4a is a cross-sectional view as seen from the plane of section line 4a-4a of FIG. 4; and

FIG. 4b is a cross-sectional view as seen from the plane of section line 4b-4b of FIG. 4.

### PARTICULAR DESCRIPTION OF AN EMBODIMENT OF THE INVENTION

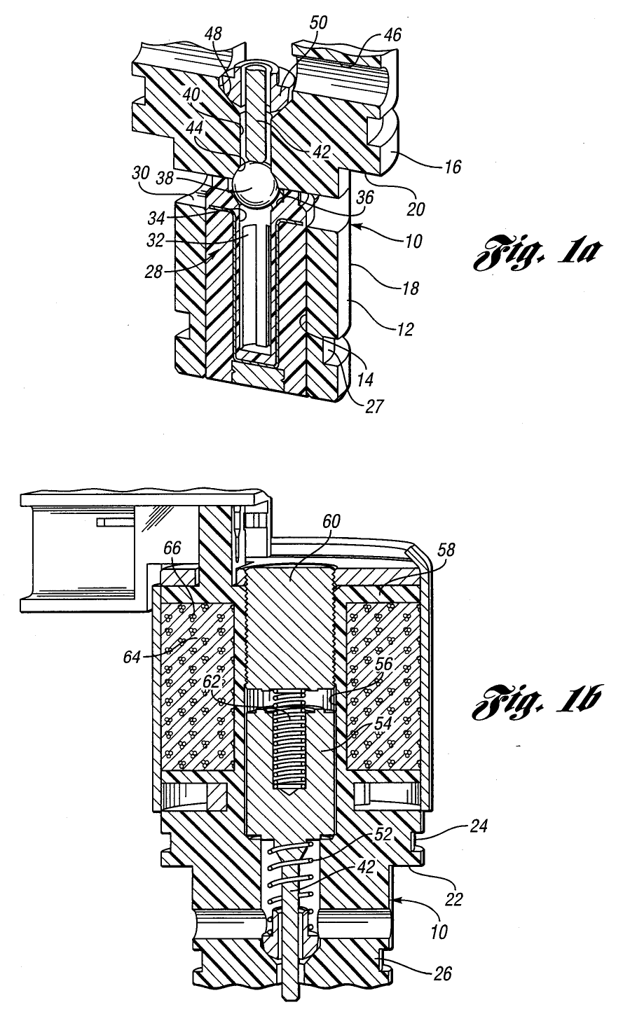

Shown in FIGS. 1a and 1b is a regulator valve and screen filter assembly 10 that includes an embodiment of the invention. A valve body 12, which may be cylindrical in shape, includes a central cylindrical opening 14. An upper cylindrical portion 16 has a diameter that exceeds the diameter of the lower portion 18. This feature defines a shoulder 20 that engages a shoulder formed on an engine block or an engine cylinder head.

The engine block or cylinder head, not shown, can be provided with a cylindrical opening that receives lower portion 18 of the assembly 10. A larger diameter portion of the opening receives large diameter portion 16 of the assembly 10. Shoulder 22, seen in FIG. 1b, engages a third shoulder formed in the opening in the cylinder block or cylinder head.

O-ring seal openings 24 and 26, seen in FIG. 1b, and o-ring seal opening 27, seen in FIG. 1a, receive o-ring seals that register with the multi-diameter opening in the engine block or cylinder head.

A cylindrical filter body 28 is received in the cylindrical opening 14 in the lower portion 18 of the valve body. It can be secured in the lower portion 18 by a press-fit. In the alternative, it may be secured in the lower portion 18 by a close-fit thread if adjustment of the axial position of the filter body with respect to the valve body is desired.

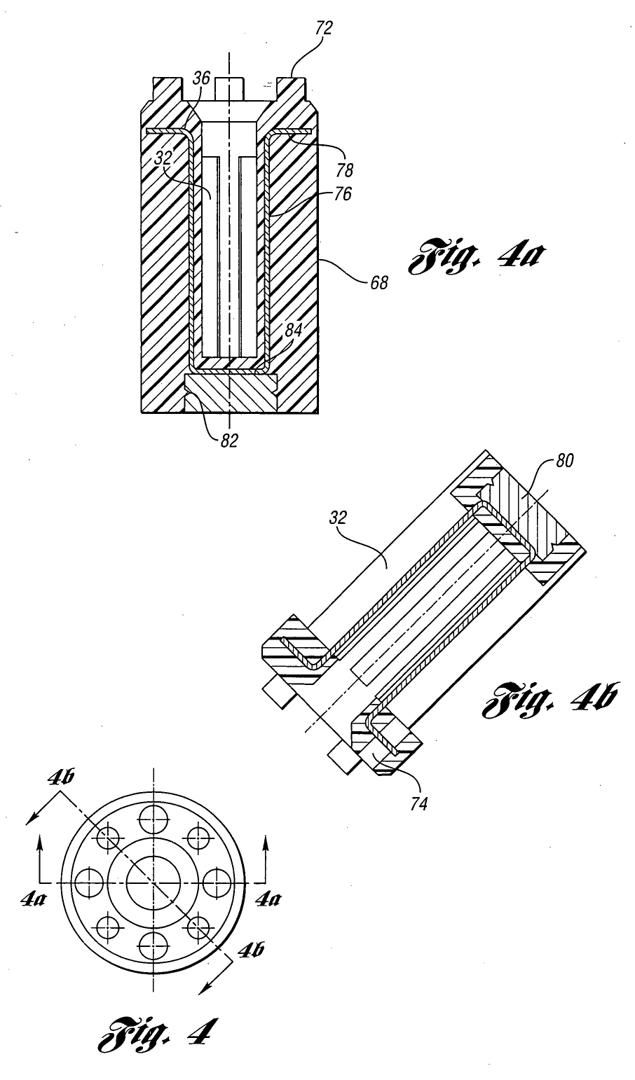

As will be explained subsequently in the descriptions of FIGS. 3, 4, 4a and 4b, a flow inlet port, seen in FIG. 1a at 30, is formed in the valve body 10. Multiple elongated oil flow passages formed in the filter body 28 communicate with the port 30. One of these flow passages is seen in FIG. 1a at 32.

The filter body 28 is provided with a central opening 34 with a blind end at 34. An open end defines a flow regulating port 36. The port 36 has a conical valve seat that registers with a ball valve element 38.

Valve body 16 is provided with a central opening 40 that receives an armature stem 42 that is engageable with ball valve element 38. The valve body 16 defines a valve seat at the lower end of the opening 40. The ball valve element 38 is adapted to register with the valve seat 36 and with the valve seat at the lower end of central passage 40.

The valve seat in valve body 16 is identified in FIG. 1a by reference numeral 44. An exhaust port in the valve body 16, shown at 46, may extend in a radial direction, as shown in FIG. 1a.

The upper end of the central opening 40 in the valve body 16 defines a conical valve seat 48 which is adapted to register with a circular valve element 50, which is loosely mounted on the armature stem 42. Valve spring 52 surrounds the armature stem 42 and urges the valve element 50 into sealing engagement with the valve seat 48.

Armature stem 42 comprises a part of armature 54, seen in FIG. 1b. Armature 54 is slidably mounted in central opening 56 formed in an upper portion 58 of the valve body 16. The upper end of the opening 56 is closed by a cylindrical closure member 60, which may be secured in place by a press-fit or by threads. A threaded connection between member 60 and the upper portion 58 of the valve body 16 would be preferred if an adjustment feature is desired for varying the spring force acting on the ball valve element 38.

A valve spring 62 seated in a central pocket in the armature 54 is situated between the member 60 and the armature 54 for exerting a downwardly directed spring force on the valve element 38.

The upper portion 58 of the valve body 16 defines an annular cavity 64 that receives a spindle comprising electrical solenoid windings 66, which surround the armature 54.

FIG. 3 is an isometric view of the filter body 28. The filter body includes multiple flutes or extensions, two of which are shown at 68 and 70. The openings between adjacent extensions define flow passages, one of which is shown in FIG. 1a at 32, which communicate with central opening 34, seen also in FIG. 1a. Projections 72 are integrally formed at the upper end of filter body 28 to provide an opening between the upper end of the filter body and the valve body 10. This opening provides communication between port 30, seen in FIG. 1a, and the central opening 34. Openings between the projections 72 are seen in FIG. 3 at 74, 74′, 74″ and 74′″.

FIG. 4a is a cross-sectional view taken along a plane that includes the plane of extension 68 and the corresponding extension located at 180 degrees from extension 68. A metallic screen 76 with magnetic properties, such as a ferrous alloy, is molded within the filter body 28. Screen 76 surrounds the openings 32 in the filter body. The upper end of the screen 76 is disposed in a radial direction, as shown at 78, so that the portion of the screen shown at 78 covers the openings 74, 74′, 74″ and 74′″. This provides communication between the central opening 34 in the filter body and the port, shown at 30 in FIG. 1a.

FIG. 4 is a top view of the filter body shown in FIG. 4a. It also indicates the location of the section lines for FIG. 4a and FIG. 4b.

FIG. 4a and FIG. 4b illustrate a permanent magnet 80, which may be cylindrical, which is secured in an opening 82 formed in the lower end of the filter body illustrated in FIG. 4a and in FIG. 1a.

The screen 76 extends downwardly, as indicated in the view of the filter body seen in FIG. 4a, and is situated in contact with the magnet 80, as indicated at 84 in FIG. 4a.

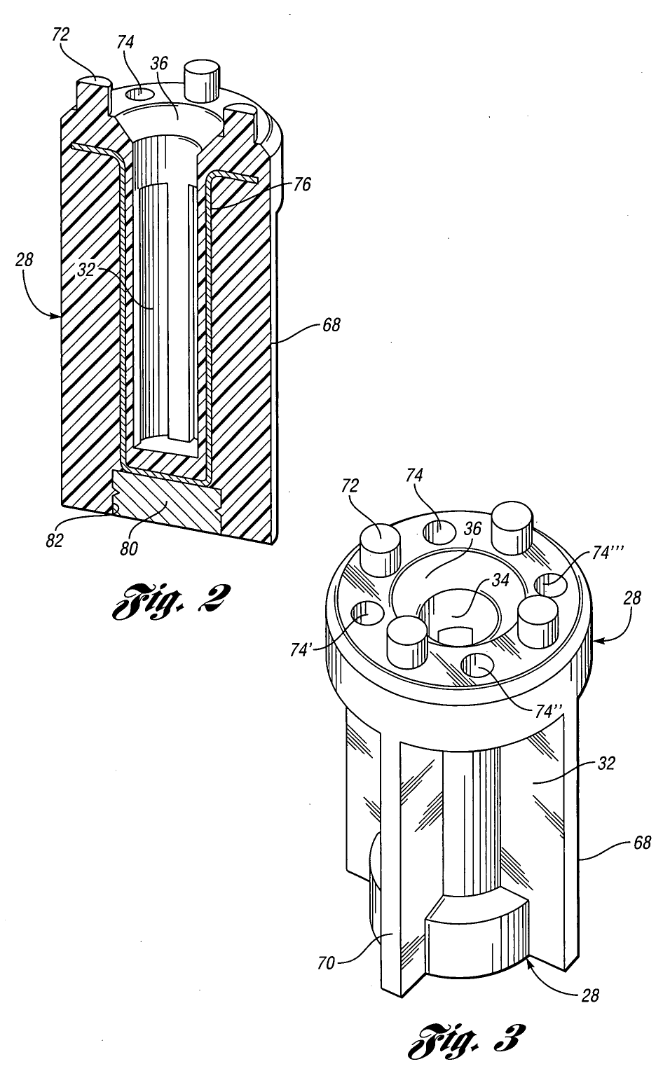

FIG. 2 is an enlarged isometric view of the filter body and the filter screen assembly, together with a magnet, which define the subassembly indicated in the cross-sectional view of FIG. 4a. The magnet 80 can be secured in place, as shown in FIG. 2, using any of a variety of assembly techniques, including a press-fit or a threaded connection. In the disclosed embodiment, the magnet 80 is over-molded in the molded filter body 28.

The filter body and the valve body in the embodiment disclosed can be a molded one-piece assembly made of a moldable thermoplastic material, such as a glass fiber reinforced thermoplastic material. The valve body can be inserted in a machined opening in an engine cylinder block, or an engine cylinder head, or otherwise located in the engine environment. The specific location is a design choice. The filter screen 76 is secured within the molded filter body using an over-molded technique. Ferrous particles can be separated from the flow of engine oil at the location of the elongated openings 32, as well as at the location of the openings 74, 74′, 74″ and 74′″.

In the embodiment as shown in FIGS. 1a and 1b, the valve element 44 is shown in a closed position as it engages the valve seat 36 under the force of armature spring 62. When the solenoid windings 66 are energized, the oil flow openings 32 are brought into communication with valve body ports 30. At this time, the armature will accommodate lifting of the ball valve 38 from engagement with the seat 36 toward engagement with seat 44. As the ball valve moves in an upward direction as viewed in FIG. 1a, communication between port 26 and port 30 is increased and communication between port 30 and port 46 is decreased.

Valve element 50 normally is urged toward a closed position against valve seat 48 by valve spring 52. Valve spring 52, which is seated on armature 52 as indicated in FIG. 1b, and the valve element 38 are calibrated so that a calibrated minimum pressure will be regulated in port 30, thereby maintaining a calibrated minimum pressure at the hydraulic engine valve lifters.

Although the disclosed embodiment of the invention is adapted for filtering oil distribution from an engine oil pump to hydraulically actuated valve lifters, it may be used as well in other engine applications. It may be used furthermore in applications other than applications involving the use of an engine oil pump and in other environments that require filtering of an oil distribution flow path.

If it desired to change the flow rate, adjusting screw threads for the member 60 can be used. Further, if a particular application for the filter body assembly requires reduced flow through the screened orifices 74, one or more of the orifices can be plugged to reduce the rate of flow. The ball valve element size also can be changed if a change in flow rate for a particular application is needed.

In some applications for the filter body, adequate filtration may be achieved when the magnet is not in place. If that is the case, the magnet can be removed readily if it is secured, for example, by a threaded fitting.

Although an embodiment of the invention has been disclosed, it will be apparent to persons skilled in the art that modifications may be made without departing from the scope of the invention as defined by the following claims.

1. A fluid filter assembly for separating debris particles from a fluid flow stream, the fluid filter assembly comprising a filter body, a fluid flow entry passage and a fluid flow exit opening in the filter body,
a valve opening in the filter body defining a valve seat for a flow control valve element, the fluid flow entry passage communicating with the fluid flow exit opening through the valve opening; and
a filter screen embedded in the filter body, the filter screen covering the fluid flow entry passage, the filter screen being an integral part of the filter body whereby debris particles are separated from the fluid flow.

2. A fluid filter assembly for separating debris particles from a fluid flow stream, the fluid filter assembly comprising a filter body, a fluid flow entry passage and a first fluid flow exit opening in the filter body,
a valve opening in the filter body defining a valve seat for a flow control valve element, the fluid flow entry passage communicating with the fluid flow exit opening through the valve opening;
a filter screen over-molded in the filter body, the filter screen covering the fluid flow entry passage, the filter screen being an integral part of the filter body; and
a second fluid flow exit opening in the filter body, the filter screen covering the second fluid filter exit opening as well as the first fluid flow entry passage.

3. A fluid filter assembly set forth in claim 1 wherein the screen is a metal having magnetic properties and wherein the filter assembly comprises a magnet disposed in the filter body;
a magnetic field for the magnet enveloping the filter screen whereby an increased magnetic field fluid flow area in the filter assembly is effective in capturing debris in the fluid flow stream.

4. A fluid filter assembly set forth in claim 2 wherein the screen is a metal having magnetic properties and wherein the filter assembly comprises a magnet disposed in the filter body;
a magnetic field for the magnet enveloping the filter screen whereby an increased magnetic field fluid flow area in the filter assembly is effective in capturing debris in the fluid flow stream.

5. A fluid filter assembly forming a part of a fluid flow control valve assembly in a fluid circuit that includes a pressure source and pressure control port in communication adapted to be connected to a pressure actuated mechanism;
the fluid flow control valve assembly comprising a valve body, a fluid flow outlet port in the valve body;
the fluid filter assembly comprising a molded filter body, a fluid flow entry passage and a fluid flow exit opening in the filter body, a valve opening in the filter body defining a valve seat for a flow control valve element, the fluid flow entry passage communicating with the fluid flow exit opening through the valve opening;
a filter screen over-molded and embedded in the filter body, the filter screen covering the fluid flow entry passage, the filter screen being an integral part of the filter body whereby debris particles are separated from the fluid flow; and
a solenoid actuator for applying a pressure regulating force on the flow control valve element to effect regulation of pressure at the fluid flow outlet port;

6. A fluid filter assembly set forth in claim 5 wherein the filter screen is formed of a metal with magnetic properties;
the filter assembly including a magnet disposed in the filter body;
a magnetic field for the magnet enveloping the filter screen whereby an increased magnetic field fluid flow area in the filter assembly is effective in capturing debris in the fluid flow stream.

7. The fluid filter assembly set forth in claim 2 wherein the magnet is effectively in contact with the screen whereby the magnet magnetizes the screen.

8. The fluid filter assembly set forth in claim 6 wherein the magnet is effectively in contact with the screen whereby the magnet magnetizes the screen.

9. The fluid filter assembly set forth in claim 5 wherein the solenoid actuator comprises an armature engageable with the valve element for applying a variable force on the valve element to seat the valve element on the valve seat;
a valve spring acting on the armature with a spring force to complement the electromagnetic force; and
means for adjusting the spring force to effect changes in a rate of fluid flow through the fluid flow exit opening.

10. The fluid filter assembly set forth in claim 5 wherein the fluid flow control valve assembly includes a pressure relief port, a pressure relief valve providing controlled communication between the fluid flow exit opening and the pressure relief port whereby a minimum pressure is maintained in the fluid flow exit opening.
